(19) United States
(12) Patent Application Publication
(10) Pub. No.: US 2011/0090082 A1
(43) Pub. Date: Apr. 21, 2011

(54) VIDEO GUARDIAN PROTECTOR SYSTEM

(76) Inventor: Lorenzo Boston, San Francisco, CA (US)

(21) Appl. No.: 12/898,732

(22) Filed: Oct. 6, 2010

Related U.S. Application Data
(60) Provisional application No. 61/252,787, filed on Oct. 19, 2009.

(51) Int. Cl. G08B 1/08

(52) U.S. Cl. 340/539.13

(57) ABSTRACT

A personal safety device comprising a housed portable transmitter that sends a communication to a receiver. The housed portable transmitter has an upper and lower portion comprising at least one clip for attaching and concealing to the clothing of the user. Further, the personal safety device has at least one push button with a silent buzzer located on a posterior side of the housed portable transmitter for activation by a user to notify authorities of a condition dangerous to the user. A Global Positioning System is used for location tracking to communicate to authorities the geographic location of the user. Additionally the personal safety device has an audio recorder having at least one speaker for relaying at least one audible signal, a video recorder to provide video tracking of the user upon activation, a holder for pens, and at least one logo. The personal safety device may be sold as a kit.

### CROSS-REFERENCE TO RELATED APPLICATION

The present application is related to and claims priority from prior provisional application Ser. No. 61/252,787, filed Oct. 19, 2009 which application is incorporated herein by reference.

### BACKGROUND OF THE INVENTION

1. Field of the Invention

The present invention relates generally to the field of personal safety devices and more specifically relates to a personal safety system with a silent alarm that utilizes Global Positioning System (GPS) to determine geographic location of a potential victim.

2. Description of the Related Art

Every day, thousands of innocent people become the victim of a terrible crime. According to the Bureau of Justice Statistics, in 2007 1,613,100 serious violent crimes actually occurred in the United States alone. The serious violent crimes included are rape, robbery, aggravated assault, and homicide. Regrettably of the 1,613,000 serious violent crimes that were committed, only 1,203,400 were reported to authorities, with only 597,400 of these leading to an arrest.

Unfortunately, these victims are often alone without access to help afterwards having only their memory to rely on as to the attacker(s)' appearance and other crucial details of the event. This information may be vital for future crime prevention. Personal safety devices have contributed to improving the ability of persons to remain safe when faced with potentially hazardous conditions. For example, GPS systems can be used to provide information about a person's location relative to satellites. Additionally, devices such as mobile telephones, or mobile telephone networks, such as cellular telephones and/or other radio transceivers can be used to make contact with authorities or rescuers if an individual is lost. User-specific devices also may include whistles, and flares, which can be used to alert passersby to imminent danger to an individual, although these devices are not able to track the perpetrators.

Home-security systems installed in a home and monitored remotely by a security office are vital in emergency situations, such as fires, home invasions, and potential assaults. These systems typically have the ability to indicate the type of assistance needed, such as the police, fire department, or an ambulance, and the location of the home where the emergency situation exists. However, a major drawback of Home-Security systems is they are limited in the distance that will be covered. Once a user leave's their home, these systems are no longer active in protecting them from imminent harm and/or injury.

Due to the increase acts of violence, such as robbery, assault, and battery personal security devices are in use today. Personal protection devices are convenient to carry, and may be extremely loud, giving the attention drawing capability an individual may need, when it matters most. These personal protection devices permit a user to wear a transmitter which may be activated when individual is put in harm's way. Once the user activates the alarm, the transmitter sends a signal containing information identifying the particular transmitter and the nature of the emergency to a remote receiver which forwards the information to emergency personnel.

A drawback of portable personal security alarms on the market today is that there is limited data relating specifically to the individual being transmitted by the transmitter to the authorities. Although the authorities such as the police and emergency personal may use GPS tracking to identify the location of a transmitter, there is limited information regarding specifics as to why the personal security alarm was activated and who is the perpetrator and why the user is in a dangerous situation. Further, if an attacker discovers a portable personal security alarm on a user, this may increase the danger and escalate the attack of the victim if the attacker knows the authorities were dispatched and immediately discard the device.

Many criminals may be deterred from their intended acts if they knew they were about to be recorded. Other options such as home surveillance systems are expensive and only provide security in certain locations of the home. Thus a need exists for a device that users may carry with them at all times to provide security.

Various solutions have been proposed for the aforementioned problems such as those found in U.S. Pat. Nos. 6,714,233, 5,926,103, and U.S. Publication Nos. 2008/0031426, 2007/0293186, 2007/0200716, 2006/0201964, and 2006/0199609 Although these patents address some of the problems stated previously, they fail to provide a personal safety device that will continue to aid in the apprehension of a suspect once the device has been disposed of by an attacker, a device that also uses GPS, audio, and video tracking in combination.

Ideally, a video guardian protector system for personal safety should record an attack that is occurring, may be conveniently carried with a user at all times to provide security, safety, be user friendly, and may be manufactured at a modest expense. Further, the video guardian protector system should be aesthetically pleasing, and easy to discretely conceal in the clothes of a user to prevent a potential attacker from knowing the device is being used. Thus, a need exists for a video guardian protector system to avoid the above-mentioned problems.

### BRIEF SUMMARY OF THE INVENTION

In view of the foregoing disadvantages inherent in the known personal safety devices art, the present invention provides a novel video guardian protector system for silently notifying authorities when a person is encountering a dangerous condition. The general purpose of the present invention, which will be described subsequently in greater detail is to provide a user with increased personal safety via an electronic personal tracking safety device having a portable GPS video and alarm system.

The present personal safety device disclosed herein preferably comprises the following components: a housed portable transmitter and a receiver. The housed portable transmitter has an upper and lower portion comprising at least one clip for attaching and concealing to the clothing of the user. Further, the personal safety device has at least one push button with a silent buzzer located on a posterior side of the housed portable transmitter for activation by a user to notify authorities of a condition dangerous to the user.

A Global Positioning System is used for location tracking to communicate to authorities as to a geographic location of the user. Additional the personal safety device has an audio recorder having at least one speaker for relaying at least one audible signal, a video recorder to provide video tracking of the user upon activation, a holder for pens, and at least one logo.

The receiver is located at a dispatching (remote) station so that when the receiver receives s signal from the transmitter, the dispatching remote station will receive the last known geographic location of the user. Furthermore, the receiver receives an audible signal from an audio recorder, video tracking via a video recorder, and dispatches emergency personnel to a designated geographic location of the user to perform at least one rescue. At least one push button on the device is compressible, a communication means is thereby activated to send a signal via the housed portable transmitter to the dispatching station allowing remote video tracking of the user.

A kit is also embodied herein for the video guardian protector system comprising: at least one housed portable transmitter having at least one push button for silent activation by a user to notify authorities of a condition dangerous to said user, a receiver, and a set of user instructions.

In accordance with the embodiments of the present invention a preferred method of use is disclosed herein comprising: step one attaching at least one housed portable transmitter to clothing of user; step two concealing at least one housed portable transmitter on the person of the user; step three compressing at least one push button thereby activating a communication means to send a signal via housed portable transmitter to dispatching station allowing remote video tracking of user when a dangerous condition exists; and step four receiving by authorities the communication signal and responding to the condition dangerous to user, thereby protecting the user from potential harm.

The present invention holds significant improvements and serves as a video guardian system. These and other features, aspects, and advantages of the present invention will become better understood with reference to the following drawings and description.

### BRIEF DESCRIPTION OF THE DRAWINGS

The figures which accompany the written portion of this specification illustrate embodiments and method(s) of use for the present invention, video guardian protector system, constructed and operative according to the teachings of the present invention.

FIG. 1 shows a perspective view illustrating Video guardian protector system in an ‘in-use’ condition according to an embodiment of the present invention.

FIG. 2 is a perspective view illustrating an anterior side of the Video guardian protector system according to an embodiment of the present invention of FIG. 1.

FIG. 3 is a perspective view illustrating a posterior side of the Video guardian protector system according to an embodiment of the present invention of FIG. 1.

FIG. 4. is a flowchart illustrating a method of use according to an embodiment of the present invention of FIGS. 1-3.

The various embodiments of the present invention will hereinafter be described in conjunction with the appended drawings, wherein like designations denote like elements.

### DETAILED DESCRIPTION

As discussed above, embodiments of the present invention relate to personal safety devices and more particularly to video guardian protector system 100 as used to notify authorities of a condition dangerous to user 110.

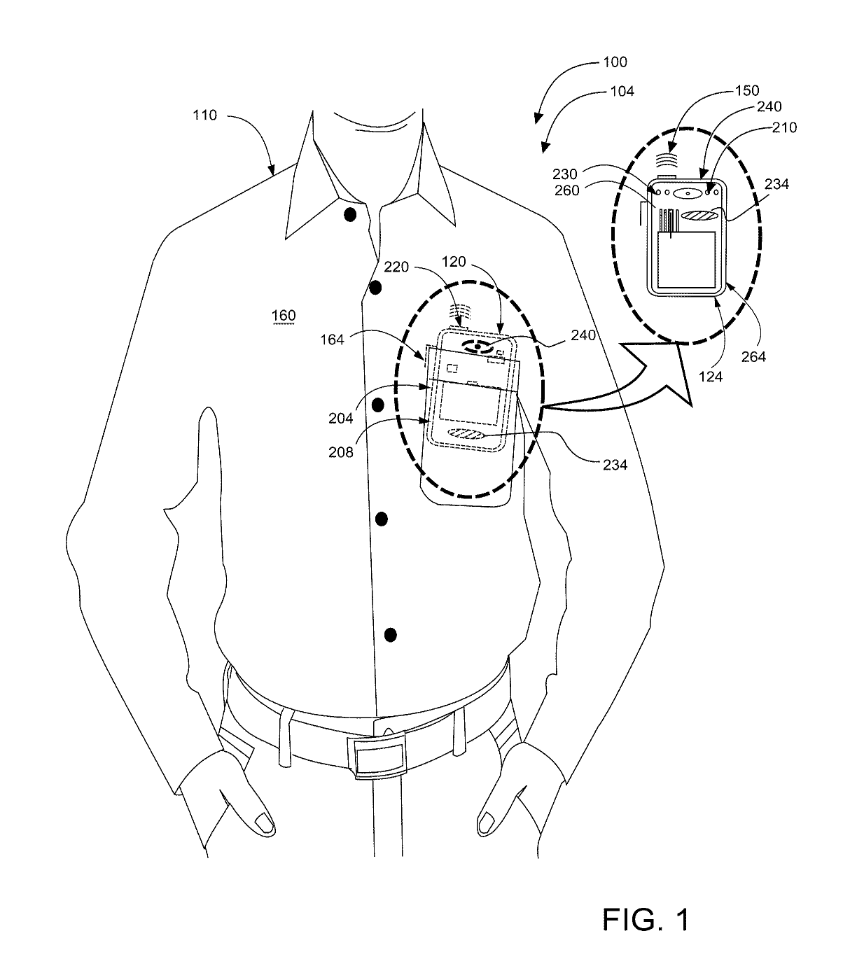

Referring to the drawings by numerals of reference there is shown in FIG. 1, a perspective view illustrating video guardian protector systems 100 in an ‘in-use’ condition 104 according to an embodiment of the present invention. Video guardian protector system 100 preferably comprises housed portable transmitter 120 and receiver 130.

Housed portable transmitter 120 may comprise an electronic device that with the aid of an antenna, propagates an electromagnetic signal 150 to at least one receiver 130. Housed portable transmitter 120 preferably comprises outer shell 124 preferably manufactured from plastic thereby protecting the interior of housed portable transmitter 120 such as in instances of water or of the device being dropped. Housed portable transmitter 120 includes both anterior side 204 and posterior side 208, and upper portion 260, and lower portion 264. Upon reading this specification, it should be appreciated that, under appropriate circumstances, considering such issues as user preferences, design preference, structural requirements, marketing preferences, cost, available materials, technological advances, etc., other materials for the outer casing such as, for example, metals, polymers, other durable materials, etc., may be sufficient.

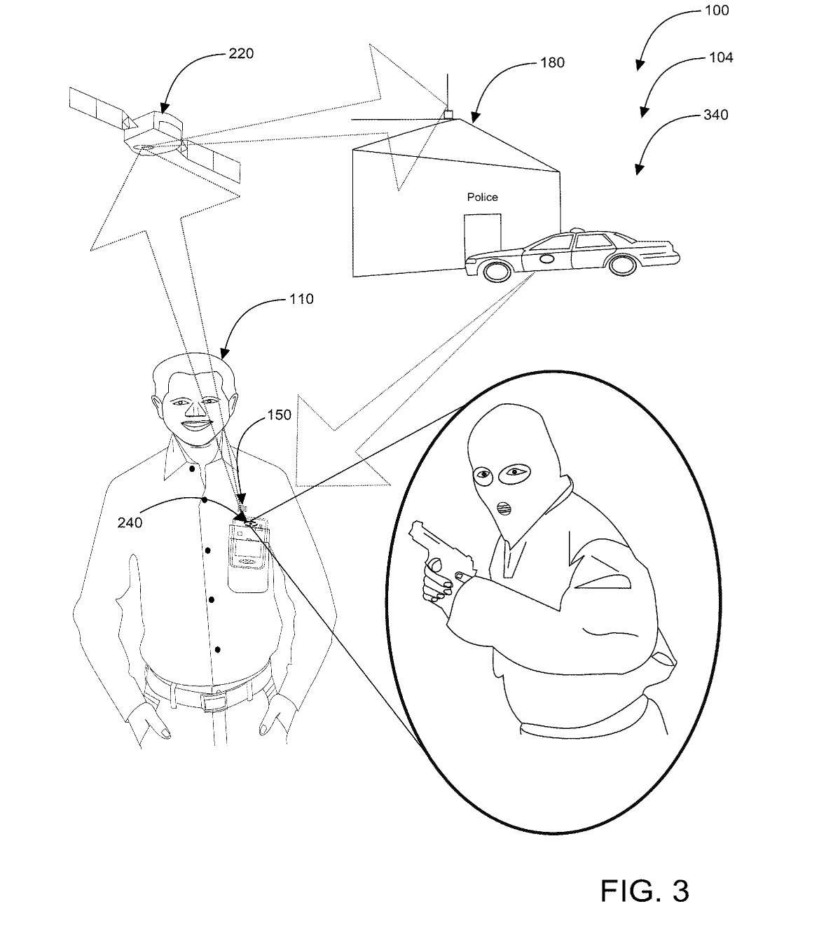

Housed portable transmitter 120 may be very small such that it may be removably attachable to clothing 160 of user 110 in a discrete fashion. Housed portable transmitter 120 may be removably attachable to clothing 160 via an attacher. The attacher preferably comprises clip 164 as shown best in FIG. 3. Further, housed portable transmitter 120 may be concealable in clothing 160 of user 110 in order to prevent a possible assailant from knowing user 110 has the necessary means to directly contact authorities. Upon reading this specification, it should be appreciated that, under appropriate circumstances, considering such issues as user preferences, design preference, structural requirements, marketing preferences, cost, available materials, technological advances, etc., other attachers such as, for example, pins, snaps, clasps, etc., may be sufficient.

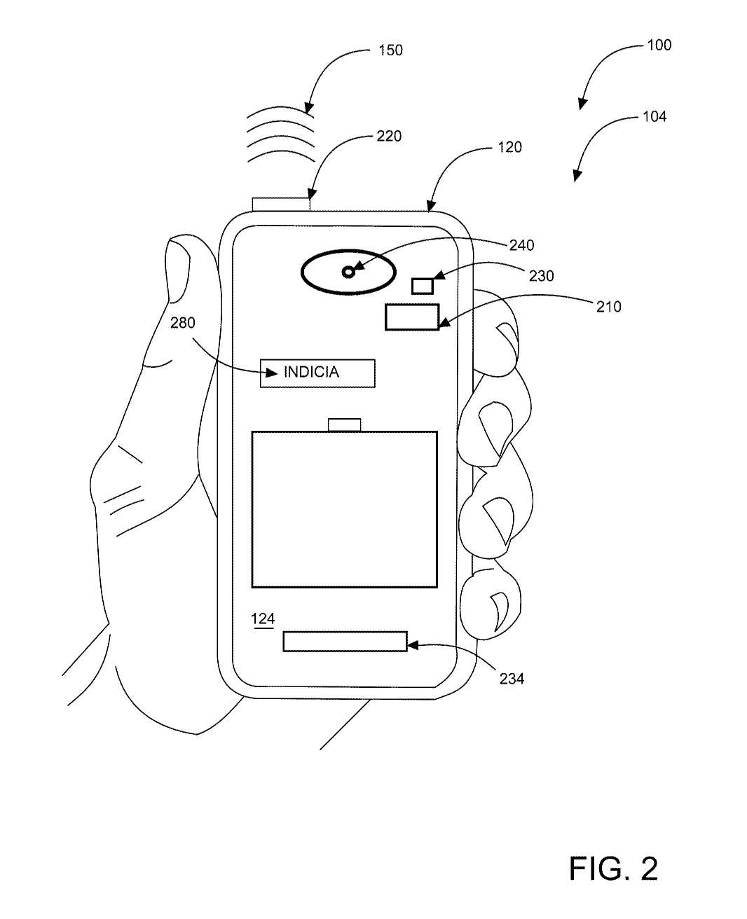

When user 110 encounters a dangerous situation, user 110 compresses at least one push button 210, as shown best in FIG. 2. Push button 210 is preferably located on housed portable transmitter 120. When push button 210 is compressed, a communication means is activated thereby sending signal 150 via housed portable transmitter to receiver 130. Housed portable transmitter 120 sends various communication means for tracking such as video, audio, and geographic location to receiver 130 as discussed further in FIGS. 2 and 3. The present invention also comprises the capability to transmit audible messages from the “guardian agent” such as warnings to the perpetrator for example “warning, your actions are being recorded, please stop now”. The system may also be used as a negotiating tool in certain embodiments.

Receiver 130 preferably comprises an electronic circuit that receives its input from an antenna, uses electronic filters to separate the wanted radio signal(s) from other signals picked up by this antenna, amplifies it to a level suitable for further processing, and finally converts through demodulation and decoding the signal into a form usable for the authorities in possession of receiver 130, such as sound, pictures, digital data, measurement values, navigational positions, etc.

Receiver 130 is preferably located at dispatch station 180. Dispatch station 180 may be located at a police station, a fire station, a first responder station, a 9-1-1 dispatcher station, etc depending on the geographic makeup of a region where user 110 is using video guardian protector system 100. Receiver 130 may use computer software to store bibliographic data specifically related to user 110 that user 110 preferably provides when registering video guardian protector system 100 online or through a secure phone line. When push button 210 is compressed and sends signal to receiver 130, dispatch station 180 may rapidly obtain information regarding the closest emergency personnel to the last tracked location of user 110 and dispatch authorities accordingly. Due to the various tracking means available for use with video guardian protector system 100, emergency personnel preferably may be provided with more precise and situation-appropriate assistance to aid user 110 depending on the level and type of danger user 110 is currently in at the time video guardian protector system 100 was activated. Upon reading this specification, it should be appreciated that, under appropriate circumstances, considering such issues as user preferences, design preference, structural requirements, marketing preferences, cost, available materials, technological advances, etc., other signal transfer means from transmitter 120 to receiver 130 may be possible, etc.

Referring now to FIGS. 2 and 3, showing a perspective views illustrating anterior side 204 and posterior side 208 of housed portable transmitter 120 according to an embodiment of the present invention of FIG. 1. Anterior side 204 of housed portable transmitter 120 preferably comprises Global Positioning System 220, audio recorder 230, and video recorder 240.

Global Positioning System 220 includes a radio navigation system that allows land, sea, and airborne users to determine their exact location, velocity, and time 24 hours a day, in all weather conditions, anywhere in the world. Global Positioning System 220 may calculate its position by precisely timing the signals sent by GPS satellites located in orbit. Each satellite continually transmits messages that include the time the message was transmitted, precise orbital information (the ephemeris) the general system health and rough orbits of all GPS satellites (the almanac).

Global Positioning System 220 on housed portable transmitter preferably location tracks user 110 permitting Global Positioning System 220 to communicate to authorities as to a geographic location of user 110. Once authorities are notified of a specific location and/or target, even if the location is a moving target such a motor vehicle, the authorities have the ability to continually track the target even if the attacker discards video guardian protector system 100.

Further, to provide authorities with additional information besides just signal 150 from receiver 130 at dispatching station 180, housed portable transmitter 120 comprises audio recorder 230 located on anterior side 204 of housed portable transmitter 120. Audio recorder 230 preferably records any verbal sounds communicated from either user 110 or the assailant along with any surrounding noises/clues to alert authorities of a more specific location of user 110 in combination with Global Positioning System 220 via at least one speaker 234. Speaker 234 relays at least one audible signal to record the attack for the transporting of this record to receiver 130.

Further tracking and recording means may include the use of video recorder 240 located on lower portion 264 of anterior side 204 of housed portable transmitter 120. Video recorder 240 preferably provides video tracking upon compression of push button 210 and possible activation of this video tracking function. When user activates housed portable transmitter 120 by the compression of push button 210, receiver 130 preferably receives signal 150 from housed portable transmitter 120, thereby permitting dispatching station 180 to receive video tracking via video recorder 240 for a more accurate visual description of the dangerous condition user 110 is under along with a physical image of thereby permitting the notifying of condition-specific authorities to aid user 110.

When user 110 is in a dangerous condition and compresses push button 210, to activate video guardian protector systems 100 by sending signal 150 from housed portable transmitter 120 to receiver 130, signal 150 preferably includes a silent buzzer and/or alarm to discreetly notify authorities as alluded to in FIG. 3. Push button 210 is preferably located on posterior side 208 of housed portable transmitter in order to not inhibit Global Position System tracking, audio tracking, and video tracking. Upon reading this specification, it should be appreciated that, under appropriate circumstances, considering such issues as user preferences, design preference, structural requirements, marketing preferences, cost, available materials, technological advances, etc., other push button 210 activation means for sending signal 150 from transmitter 120 to receiver 130 may be possible such as an electric switch, or an On/Off button, etc.

It should be noted that when push button 140 is compressed and sent to receiver 130, the signal may audible or silent, user 110 may customize as to whether audio recorder 230 is activated to record an audible signal or not. In certain embodiments both options may be present. User 110 may choose to activate video tracker 240 to have the dangerous condition video recorded and sent to receiver 130 when a condition dangerous to user 110 is perceived. Global Positioning System 220 tracking will also be enabled once push button 210 is compressed. To activate both audio recorder 230 and video tracker 240, user 110 may compress a button and/or move a switch to activate both of these recorders to provide more complete details of the dangerous condition to the authorities. Also, user 110 may choose to automatically set housed portable transmitter 120 to record audible signals/messages via audio recorder 230 and video track via video recorder 240 any time push button 210 is compressed. At this time preferably a silent buzzer in the form of signal 150 is sent to receiver 130.

If a potential attacker knew that he/she could be video tracked and audio tracked via video recorder 240 and audio recorder 230 while committing a potential crime, the potential culprit may be dissuaded from carrying out a given crime thereby increasing the safety of the population as a whole. In this way the present invention serves to promote public and individual safety. Furthermore, if user 110 activates both video recorder 240 and audio recorder 230 when placed in a dangerous condition, law enforcement will have more potential evidence of the physical appearance of the attacker and what actually occurred during the crime. Verbal exchanges that took place may also be recorded thereby increasing the likelihood of apprehension and prosecution of the assailant in the courtroom.

Located on upper portion 260 on anterior side 204 of housed portable transmitter may be logo 280. Logo 280 may include advertising means for specific licensing and/or marketing of Video guardian protector system 100. Further, logo 280 may include a favorite sports team of user 110, or feature various user-selected designs and colors customizable per request of user 110.

If user 110 decides to conceal housed portable transmitter 120 in a pocket of their clothing, housed portable transmitter may conveniently include holder for pens 290 or other small items user 110 may possess. Lastly, even if user 110 is not immediately involved in a crime but is witness of such a crime, they could use video guardian protector system 100 to call for help and in so doing aid the police in their investigation. In addition to civilian security, video guardian protector system 100 may prove useful to military and police personnel. Potential users 110 such as children, college students, adults, the elderly and other individuals could benefit from the safety features video guardian protector system 100 provides.

Video guardian protector system 100 according to an embodiment of the present invention of FIGS. 1-3 may comprise kit 340. Kit 340 may comprise the following parts: at least one housed portable transmitter 120 having at least one push button 140 for silent activation by user 110 to notify authorities of a condition dangerous to user 110, receiver 130, and set of user instructions 350. Kit 340 may be manufactured and provided for sale in a wide variety of sizes and shapes for a wide assortment of applications. Further, the various components may be interchangeable between kits 340. Upon reading this specification, it should be appreciated that, under appropriate circumstances, considering such issues as user preferences, design preference, structural requirements, marketing preferences, cost, available materials, technological advances, etc., other exercising methods and motions may be performed with the present invention as well as other configurations may be possible, etc., may be sufficient.

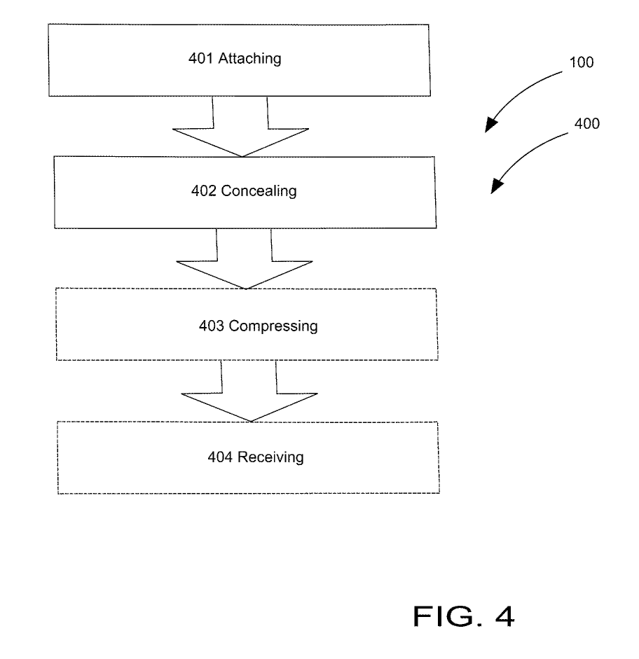

Referring now to FIG. 4 showing flowchart 450 illustrating a method of use 400 according to an embodiment of the present invention of FIGS. 1-3.

In accordance with the embodiments of the present invention a preferred method of use 400 is disclosed herein comprising: step one 401 attaching at least one housed portable transmitter 120 to clothing 160 of user 110; step two 402 concealing at least one housed portable transmitter 120 on the person of user 110; step three 403 compressing at least one push button 210 thereby activating a communication means to send a signal via housed portable transmitter 120 to dispatching station 180 allowing remote video tracking of user 110; and step four 404 receiving by authorities the communication signal responding to a condition dangerous to user 110.

It should be noted that the steps described in method of use 400 can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain exercise or storing steps, including or excluding certain steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention.

What is claimed is new and desired to be protected by Letters Patent is set forth in the appended claims:

1. An electronic personal tracking safety device comprising:
a housed portable transmitter having at least one push button located on a posterior side of said housed portable transmitter for activation by a user to notify authorities of a condition dangerous to said user;
at least one receiver located at a remote dispatching station;
wherein when said push button is compressible, thereby activating a communication means to send a signal via said housed portable transmitter to said dispatching station allowing remote video tracking of said user.

2. The electronic personal tracking safety device of claim 1 wherein said housed portable transmitter is concealable in clothing of said user.

3. The electronic personal tracking safety device of claim 2 wherein said housed portable transmitter comprises at least one removable attacher for removable attaching to said clothing of said user.

4. The electronic personal tracking safety device of claim 3 wherein said at least one removable attacher comprises at least one clip.

5. The electronic personal tracking safety device of claim 1 wherein said housed portable transmitter comprises a Global Positioning System for location tracking of said user.

6. The electronic personal tracking safety device of claim 5 wherein said Global Positioning System is able to communicate to authorities as to a geographic location of said user.

7. The electronic personal tracking safety device of claim 1 wherein said housed portable transmitter comprises an audio recorder.

8. The electronic personal tracking safety device of claim 7 wherein said audio recorder further comprises at least one speaker for relaying at least one audible signal.

9. The electronic personal tracking safety device of claim 1 wherein said housed portable transmitter comprises an upper portion and a lower portion.

10. The electronic personal tracking safety device of claim 9 wherein said lower portion of said housed portable transmitter comprises a video recorder to provide said video tracking said user upon activation.

11. The electronic personal tracking safety device of claim 1 wherein when said push button is activated and a silent buzzer notifies said authorities.

12. The electronic personal tracking safety device of claim 9 wherein said upper portion of said housed portable transmitter comprises at least one logo.

13. The electronic personal tracking safety device of claim 1 wherein said housed portable transmitter comprises a holder for pens.

14. The electronic personal tracking safety device of claim 5 wherein said receiver receives said signal from said transmitter, whereupon said dispatching remote station receives the last known said geographic location of said user and dispatches emergency personnel to such said geographic location of said user to perform at least one rescue.

15. The electronic personal tracking safety device of claim 8 wherein upon said receiver receiving a signal from said transmitter, said remote dispatching station receives said at least one audible signal from said audio recorder.

16. The electronic personal tracking safety device of claim 10 wherein upon said receiver receiving a signal from said transmitter, said dispatching (remote) station receives said video tracking via said video recorder.

17. The electronic personal tracking safety device of claim 14 wherein upon said a dispatching (remote) station receives a signal from said receiver via said transmitter, authorities are notified and directed to said last geographic location of said user.

18. An electronic personal tracking safety device comprising:
a housed portable transmitter with an upper and lower portion comprising at least one clip for attaching and concealing to clothing of a user having at least one push button with a silent buzzer located on a posterior side of said housed portable transmitter for activation by said user to notify authorities of a condition dangerous to said user, a Global Positioning System for location tracking to communicate to authorities as to a geographic location of said user, an audio recorder having at least one speaker for relaying at least one audible signal, a video recorder to provide video tracking to said user upon activation, a holder for pens; at least one logo; and
at least one receiver located at a dispatching station that when said receiver receives said signal from said transmitter, whereupon said dispatching remote station receives the last known said geographic location of said user, receives said at least one audible signal from said audio recorder, receives said video tracking captured via said video recorder, and said dispatching station dispatches emergency personnel to such said geographic location of said user to perform at least one rescue.
wherein when said push button is compressible, thereby activating a communication means to send a signal via said housed portable transmitter to said dispatching station allowing remote video tracking of said user.

19. The electronic personal tracking safety device of claim 18 wherein components comprise a kit including at least one housed portable transmitter having at least one push button for silent activation by a user to notify authorities of a condition dangerous to said user, a receiver, and a set of user instructions.

20. A method of using a video guardian protector system comprising the steps of:
attaching at least one housed portable transmitter to clothing of a user;
concealing said at least one housed portable transmitter on person of said user;
compressing at least one push button thereby activating a communication means to send a signal via said housed portable transmitter to a dispatching station allowing remote video tracking of said user;
receiving by authorities said communication signal responding to a condition dangerous to said user.
